(19) United States
(12) Patent Application Publication
(10) Pub. No.: US 2025/0015669 A1
(43) Pub. Date: Jan. 9, 2025

(54) METHOD AND SYSTEM FOR GENERATING ELECTRICITY IN AN ENERGY-SAVING WAY

(71) Applicant: Feng-Tien CHEN, Taichung City (TW)

(72) Inventor: Feng-Tien CHEN, Taichung City (TW)

(21) Appl. No.: 18/376,629

(22) Filed: Oct. 4, 2023

(30) Foreign Application Priority Data
Jul. 3, 2023 (TW) 112124793

(51) Int. Cl. H02K 7/02; H02K 1/16; H02K 1/27; H02K 7/18

(52) U.S. Cl. CPC H02K 7/02; H02K 1/16; H02K 1/27; H02K 7/1807

(57) ABSTRACT

A method for generating electricity in an energy-saving way includes at least the following steps: preparing a first electrical machine capable of being operated as a motor or both a motor and a generator, preparing a second electrical machine device capable of being operated as a motor or a generator, and coupling a flywheel to the first electrical machine and the second electrical machine, driving the flywheel in a way that the first and electrical machines are simultaneously operated as a motor when the flywheel is in a stationary state, and driving the flywheel in a way that the first electrical machine is operated as a motor or both a motor and a generator and the second electrical machine is operated as a generator when the flywheel runs at a predetermined speed. And a system is configured for executing the aforementioned method.

### FIELD

The disclosure relates to method and system for generating electricity, and particularly to a method and system for generating electricity in an energy-saving way.

### BACKGROUND

In U.S. Pat. No. 10,122,240, an electricity generation device with low power consumption is disclosed. The device has an operating module, a first motor, and a second motor. In operation, the electricity is inputted to the first motor to actuate the first motor in a short time, the first motor drives a transmission assembly of the operating module to rotate, and the transmission assembly drives a flywheel of the operating module to rotate. A generator rotor is mounted around the flywheel, and a generator stator is mounted around an inner peripheral surface of the body. The second motor is driven by the transmission assembly. When the flywheel reaches a certain rotational speed, the second motor only needs a low current input to keep operating. That is, the second motor can be continuously operated, and the flywheel generates rotor power, thereby achieving power generation at low energy consumption. Such a device has following disadvantages: 1. it must have two motors to drive the flywheel at different stages; 2. It must cooperate with a complex transmission assembly to operate; 3. It needs a body for mounting the generator stator and housing the flywheel and the generator rotor is mounted on the flywheel, which will increase the consumed electric energy to drive the flywheel and the difficulty of manufacturing.

### SUMMARY

Therefore, an object of the present disclosure is to provide a method and system to solve the disadvantages in the prior art. In other words, a method and system for generating electricity in an energy-saving way is disclosed herein. The method for generating electricity in an energy-saving way comprises the steps of preparing a first electrical machine, the first electrical machine having a first or second operating mode wherein the first operating mode is that the first electrical machine operates in a motor mode, and the second operating mode is that the first electrical machine operates in a motor mode or in a motor mode and a generator mode at the same time; preparing a second electrical machine, the second electrical machine having a third and fourth operating modes, wherein the third operating mode is that the second electrical machine operates in a motor mode, and the fourth operating mode is that the second electrical machine operate in generator mode; coupling a first flywheel to the first electrical machine and the second electrical machine respectively; driving the first flywheel in a first control mode when it is in a stationary state wherein the first control mode is that first electrical machine is operated in the first operating mode or the second operating mode that operates in the motor mode and the second electrical machine is operated in the third operating mode; and driving the first flywheel in a second control mode when it runs at a predetermined speed wherein the second control mode is that the first electrical machine is operated in the first operating mode or the second operating mode that operates in the motor mode and the generator mode at the same time, and the second electrical machine is operated in the fourth operating mode.

In one embodiment, the method of generating electricity in an energy-saving way further comprises the steps of preparing a third electrical machine, the third electrical machine having a fifth and sixth operating mode wherein the fifth operating mode is that the third electrical machine operates in a motor mode, and the sixth operating mode is that the third electrical machine operates in a generator mode; coupling a second flywheel to the first electrical machine and the third electrical machine respectively; driving the second flywheel in a third control mode when it is in a stationary state wherein the third control mode is that first electrical machine is operated in the first operating mode or the second operating mode that operates in the motor mode and the third electrical machine is operated in the fifth operating mode; and driving the second flywheel in a fourth control mode when it runs at a predetermined speed wherein the fourth control mode is that the first electrical machine is operated in the first operating mode or the second operating mode that operates in the motor mode and the generator mode at the same time, and the third electrical machine is operated in the sixth operating mode.

In another aspect, the disclosure is to provide a system for generating electricity in an energy-saving way. The system comprises a first electrical machine, a second electrical machine, a first flywheel and a first controlling unit. The first electrical machine has a first or second operating mode wherein the first operating mode is that the first electrical machine operates in a motor mode, and the second operating mode is that the first electrical machine operates in a motor mode or in a motor mode and a generator mode at the same time. The second electrical machine has a third and fourth operating modes wherein the third operating mode is that the second electrical machine operates in a motor mode, and the fourth operating mode is that the second electrical machine operates in a generator mode. The first flywheel is coupled to the first electrical machine and the second electrical machine respectively. The first controlling unit has a first and second control mode wherein the first control mode is to operate the first electrical machine in the first operating mode or the second operating mode that operates in the motor mode and the second electrical machine in the third operating mode for driving the first flywheel from a stationary state, and the second control mode is to operate the first electrical machine in the first operating mode or the second operating mode that operates in the motor mode and the generator mode at the same time, and the second electrical machine in the fourth operating mode when the first flywheel runs at a predetermined speed.

In some embodiments, the second electrical machine comprises a second stator and a second rotor The second stator comprises a second stator body and a second three-phase stator winding disposed in the stator body. The second rotor comprises a second rotor body and a plurality of permanent magnets being respectively disposed on the second rotor body. Whereby, when the first flywheel is to run from a stationary state, the second electrical machine is controlled by the first control mode in a way that the second electrical machine can be operated in a motor mode and when the first flywheel runs at a predetermined speed, the second electrical machine is controlled by the second control mode in a way that the second electrical machine operate in a generator mode.

Implementations may include one or more the following features. For example, the first controlling unit comprises a first electrical controlling means, a first variable-frequency drive and a three-phase first switch. The first electrical machine is electrically connected to an external power supply via the first electrical controlling means for being controlled thereby. The first electrical controlling means is electrically connected to the three-phase first switch to control the connection and disconnection of the three-phase first switch. The first variable-frequency drive is electrically connected to an external power supply and to the second electrical machine via the three-phase first switch. Whereby, when the three-phase first switch is in the connection state by the control of the first electrical controlling means, the second electrical machine can be operated in a motor mode via the first variable-frequency drive, that is, in the third operating mode and when the three-phase first switch is in the disconnection state by the control of the first electrical controlling means, the second electrical machine can be operated in a generator mode, that is, in the fourth operating mode.

In some embodiments, the first electrical machine comprises a first stator and a first rotor. The first stator comprises a first stator body and a three-phase first stator winding disposed in the stator body. Each phase first stator winding of the three-phase first stator winding comprises a first winding and a second winding. The first winding has a first number of magnetic poles and a first rated output power. The second winding has a second number of magnetic poles being equal to the first number of magnetic poles and a second rated output power. The first rated output power is greater than or equal to the second rated output power. The first rotor comprises a third number of magnetic poles and a shaft. The third number of magnetic poles is the same as the first number of magnetic poles or the second number of magnetic poles. Whereby, when the first winding and the second winding are simultaneously electrically connected to an external power supply by the control of the first controlling unit, the first electrical machine is operated in the motor mode of the second operating mode; and when only the second winding is electrically connected to the external power supply by the control of the first controlling unit, the first electrical machine is operated in the second operating mode operating in the motor mode and the generator mode at the same time.

In another embodiment, the second electrical machine comprises a second stator and a second rotor. The second stator comprises a second stator body and a second three-phase stator winding disposed in the stator body. The second rotor comprises a second rotor body and a plurality of permanent magnets being respectively disposed on the second rotor body. Whereby, when the first flywheel is to run from a stationary state, the second electrical machine is controlled by the first control mode in a way that the second electrical machine can be operated in a motor mode and when the first flywheel runs at a predetermined speed, the second electrical machine is controlled by the second control mode in a way that the second electrical machine operate in a generator mode.

Implementations may include one or more the following features. For example, the first controlling unit comprises a second electrical controlling means, a first variable-frequency drive, a three-phase first switch and a three-phase second switch. The second electrical controlling means is electrically connected to the three-phase first switch to control the connection and disconnection thereof. The first variable-frequency drive is electrically connected to an external power supply and to the second three-phase stator winding of the second electrical machine via the three-phase first switch. The second electrical controlling means is electrically connected to the three-phase second switch to control the connection and disconnection thereof. An input end of the three-phase second switch is electrically connected to the external power supply. The first winding of the first electrical machine is electrically connected to an output end of the three-phase second switch, the second winding of the first electrical machine is electrically connected to the external power supply. Whereby, when the three-phase first switch is in the connection state by the control of the second electrical controlling means, the second electrical machine can be operated in a motor mode via the first variable-frequency drive, that is, in the third operating mode and when the three-phase first switch is in the disconnection state by the control of the first electrical controlling means, the second electrical machine can be operated in a generator mode, that id, in the fourth operating mode, when the three-phase second switch is in the connection state by the control of the second electrical controlling means, the first winding and the second winding of the first electrical machine are electrically connected to an external power supply via the three-phase second switch so that the first electrical machine can be operated in a motor mode of the second operating mode, when the three-phase second switch is in the disconnection state by the control of the second electrical controlling means, only the second winding is electrically connected to the external power supply, that is, the first electrical machine is operated in the motor mode and the generator mode of the second operating mode at the same time.

In another aspect, the system for generating electricity in an energy-saving way according to the disclosure further comprises a third electrical machine and a second flywheel. The third electrical machine has a fifth and sixth operating modes wherein the fifth operating mode is that the third electrical machine operates in a motor mode, and the sixth operating mode is that the third electrical machine operates in a generator mode. The second flywheel is coupled to the first electrical machine and the third electrical machine respectively. The fist controlling unit further has a third control mode wherein the third control mode is to operate the first electrical machine in the first operating mode or the second operating mode that operates in the motor mode, and the third electrical machine in the fifth operating mode for driving jointly the second flywheel from a stationary state, and to operate the first electrical machine in the second operating mode that operates in the motor mode and the generator mode, and the third electrical machine in the sixth operating mode when the first flywheel runs at a predetermined speed.

### BRIEF DESCRIPTION OF THE DRAWINGS

Other features and advantages of the disclosure will become readily apparent to those skilled in the art from the following detailed description of the embodiments in the light of the accompanying drawings, in which:

FIG. 1 is a flowchart of a first embodiment of the method for generating electricity in an energy-saving way according to the disclosure;

FIG. 2 is a flowchart of a second embodiment of the method for generating electricity in an energy-saving way according to the disclosure;

FIG. 3 is a side view of a first embodiment of the system for generating electricity in an energy-saving way according to the disclosure;

FIG. 4 is a perspective view of some parts of a second electrical machine of the first embodiment shown in FIG. 3;

FIG. 5 is a block diagram of electrical connections of the first embodiment shown in FIG. 3;

FIG. 6 is a side view of a second embodiment of the system for generating electricity in an energy-saving way according to the disclosure;

FIG. 7 is a perspective view of some parts of a first electrical machine of the second embodiment shown in FIG. 6;

FIG. 8 is a cross-sectional view taken along the direction 8-8 of FIG. 7;

FIG. 9 is a block diagram of electrical connections between the stator winding and the first electrical controlling means of the first electrical machine of the second embodiment shown in FIG. 6;

FIG. 10 is a block diagram of electrical connections of the second embodiment shown in FIG. 6;

FIG. 11 is a side view of a third embodiment of the system for generating electricity in an energy-saving way according to the disclosure;

FIG. 12 is a side view of a fourth embodiment of the system for generating electricity in an energy-saving way according to the disclosure;

FIG. 13 is a block diagram of electrical connections of the fourth embodiment shown in FIG. 12; and

FIG. 14 is a side view of a fifth embodiment of the system for generating electricity in an energy-saving way according to the disclosure.

### DETAILED DESCRIPTION

In the description of the present disclosure, unless specified or limited otherwise, it should be noted that, terms “mounted”, “connected”, “coupled” and “electrical controlling” may be understood broadly, such as electrical connection or mechanical connection, inner communication between two elements, direct connection or indirect connection via intermediary. These having ordinary skills in the art should understand the specific meanings in the present disclosure according to specific situations. And in the following description of the drawings, the same or similar portions are given the same or similar reference numerals.

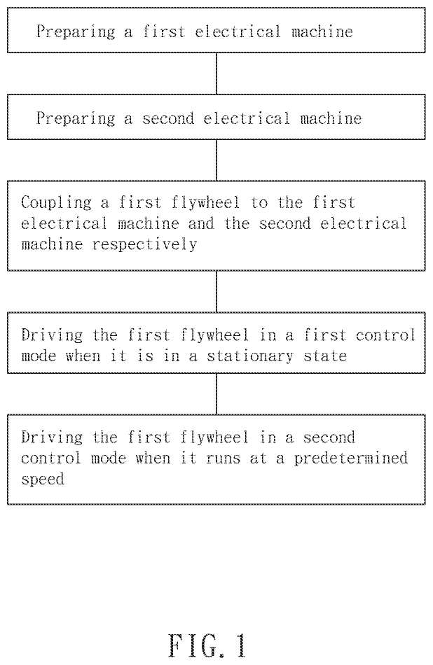

Referring firstly to FIG. 1, it shows a first embodiment of the method for generating electricity in an energy-saving way according to the disclosure. The method comprises the steps of preparing a first electrical machine, the first electrical machine having a first or second operating mode wherein the first operating mode is that the first electrical machine operates in a motor mode, and the second operating mode is that the first electrical machine operates in a motor mode or in a motor mode and a generator mode at the same time; preparing a second electrical machine, the second electrical machine having a third and fourth operating modes, wherein the third operating mode is that the second electrical machine operates in a motor mode, and the fourth operating mode is that the second electrical machine Operate in generator mode; coupling a first flywheel to the first electrical machine and the second electrical machine respectively; driving the first flywheel in a first control mode when it is in a stationary state wherein the first control mode is that first electrical machine is operated in the first operating mode or the motor mode of the second operating mode and the second electrical machine is operated in the third operating mode; and driving the first flywheel in a second control mode when it runs at a predetermined speed wherein the second control mode is that the first electrical machine is operated in the first operating mode or the second operating mode that operates in the motor mode and the generator mode at the same time, and the second electrical machine is operated in the fourth operating mode.

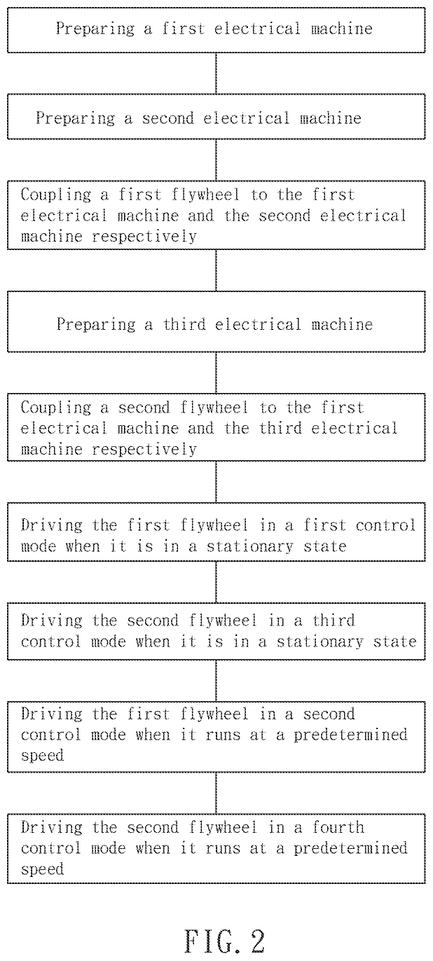

Referring then to FIG. 2, it shows a second embodiment of the method for generating electricity in an energy-saving way according to the disclosure. The difference between the second embodiment and the first embodiment is that the former further comprises the steps of preparing a third electrical machine, the third electrical machine having a fifth and sixth operating mode wherein the fifth operating mode is that the third electrical machine operates in a motor mode, and the sixth operating mode is that the third electrical machine operates in a generator mode; coupling a second flywheel to the first electrical machine and the third electrical machine respectively; driving the second flywheel in a third control mode when it is in a stationary state wherein the third control mode is that first electrical machine is operated in the first operating mode or the motor mode of the second operating mode and the third electrical machine is operated in the fifth operating mode; and driving the second flywheel in a fourth control mode when it runs at a predetermined speed wherein the fourth control mode is that the first electrical machine is operated in the first operating mode or the second operating mode that operates in the motor mode and the generator mode at the same time and the third electrical machine is operated in the sixth operating mode. It must be mentioned that the specific order described herein is not necessary.

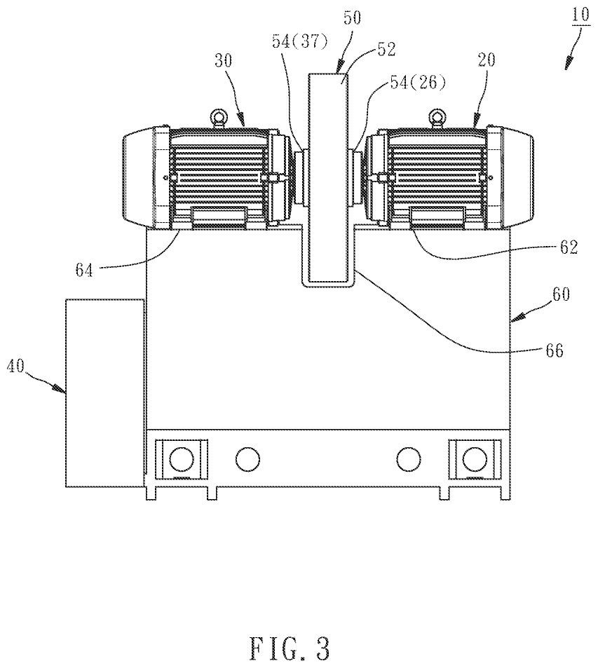

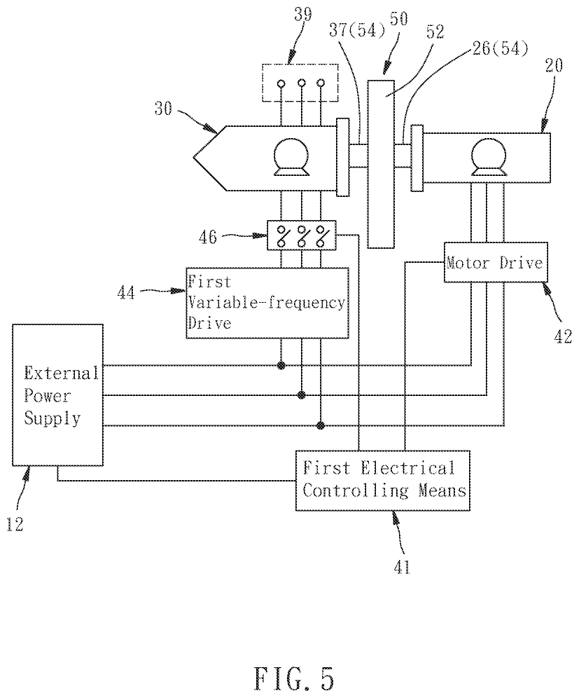

Referring firstly to FIG. 3 to FIG. 5, a first embodiment of the system for generating electricity in an energy-saving way according to the disclosure is shown at 10. The system 10 comprises a first electrical machine 20, a second electrical machine 30, a first controlling unit 40, a first flywheel 50 and a first base 60.

In this embodiment, the first electrical machine 20 is a three-phase, four poles, three-phase induction or synchronous motor with a rated output power of 20 HP. In other words, the first electrical machine 20 is a motor, that is, in a first operating mode.

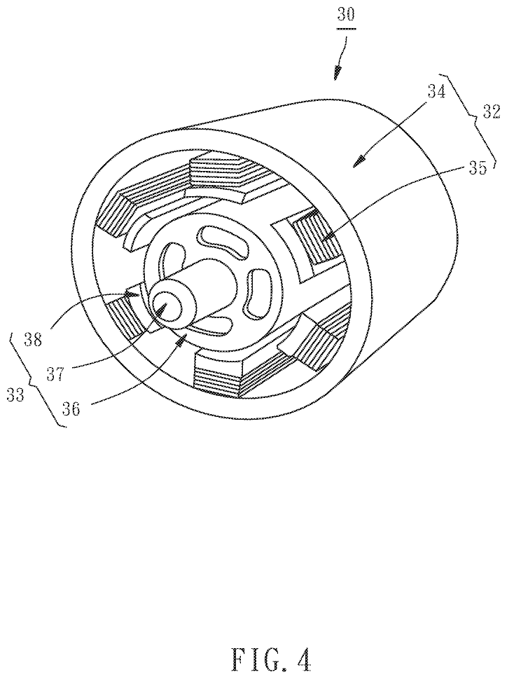

The second electrical machine 30, as shown in FIG. 4, in this embodiment, is a permanent-magnet synchronous motor-generator with a rated output power of 50 HP. It should be noted that the permanent magnet synchronous motor-generator mentioned herein is a commercially available product, and the rated output power is only used for illustration. Generally speaking, the second electrical machine 30 includes a second stator 32 and a second rotor 33. The second stator 32 comprises a second stator body 34 and a second three-phase stator winding 35 disposed in the stator body 32. The second rotor 33 comprises a second rotor body 36 and a plurality of permanent magnets 38 being respectively disposed on the second rotor body 36.

The first controlling unit 40 is configured to be operated in a first and second control mode. In this embodiment, the first controlling unit 40 comprises a first electrical controlling means 41, a motor drive 42, a first variable-frequency drive 44 and a three-phase first switch 46.

The first electrical controlling means 41 can generally be a programmable logic controller (PLC for short). The motor drive 42 is selected from one of the commercially available motor drivers. The three-phase first switch 46 can be a relay, an electromagnetic switch or other similar devices. The first variable-frequency drive 44 is a conventional variable-frequency drive. In this embodiment, in addition to be electrically connected to an external power supply 12, the first electrical controlling means 41 is respectively electrically connected to the three-phase first switch 46 and the motor drive 42 to control the connection and disconnection of the three-phase first switch 46 and to control the operation of the motor drive 42. An output end of the motor drive 42 is electrically connected to the first electrical machine 20. The first variable-frequency drive 44 has an input end electrically connected to the external power supply 12 and an output electrically connected to an input of the three-phase first switch 46. The three-phase first switch 46 has an output electrically connected to the second three-phase stator winding 35 and an input end electrically connected to the first variable-frequency drive 44.

Whereby, when the three-phase first switch 46 is in the connection position by the control of the first electrical controlling means 41, the second electrical machine 30 can be used as a motor through the first variable-frequency drive 44, that is, in a third operating mode. When the three-phase first switch 46 is in the disconnection position by the control of the first electrical controlling means 41, the second electrical machine 30 is driven by the first flywheel 50 through the first electrical machine 20 (the combination of the two will be described in detail below) to be used as a generator, that is, in a fourth operating mode.

The first flywheel 50, as shown in FIG. 3, has a weight of 30 kg and includes a first circular body 52 and a drive shaft 54. One end of the drive shaft 54 is coupled to a first rotor shaft 26 of the first electrical machine 20 so that the first flywheel 50 can be driven by the first electrical machine 20. The other end of the drive shaft 54 is coupled to a second rotor shaft 37 of the second rotor body 36 so that when the second electrical machine 30 operates in the motor mode, the first flywheel 50 is driven by the second rotor 36 of the second electrical machine 30 and when the first flywheel 50 runs at a predetermined speed, the second electrical machine 30 is driven by the first flywheel 50 to be operated in the generator mode.

The first base 60 includes a first seat 62, a second seat 64 and a first recess 66 between the first and second seats 62, 64. The first electrical machine 20 is mounted on the first seat 62 and the second electrical machine 30 is mounted on the second seat 64. In this embodiment, the first seat 62 and the second seat 64s are located on a horizontal plane so that a part of the first circular body 52 of the first flywheel 50 is suspended in the first recess 66.

The operation of the first embodiment 10 is described in detail as follows:

1. When the first flywheel 50 is to be started from a stationary state, the first controlling unit 40 is in the first control mode. Under the first control mode, the first electrical machine 20 is in the first operating mode via the motor drive 42 controlled by the first electrical controlling means 41 and the second electrical machine 30 is in the third operating mode via the first frequency converter 44 and the three-phase first switch 46 which are controlled by the first electrical controlling means 41. Thus, the first flywheel 50 will be driven by the combined force of the first electrical machine 20 and the second electrical machine 30 to start running.

2. When the first flywheel 50 runs to a predetermined speed that generates the flywheel effect, the first controlling unit 40 is in the second control mode. Under the second control mode, the first electrical machine 20 is still in the first operating mode controlled by the first electrical controlling means 41 and the three-phase first switch 46 is in disconnection position controlled by the first electrical controlling means 41 so that the second electrical machine 30 is driven by the first flywheel 50 via the first electrical machine 20 to be used as a generator, that is, in the fourth operating mode. In other words, when the first controlling unit 40 is in the second control mode, the second electrical machine 30 will operate in the generator mode via the flywheel effect of the first flywheel 50 to output electrical energy to the outside through the output end 39 of the second electrical machine 30.

Based on the aforementioned description, it can be understood that one advantage of the first embodiment 10 lies in the simultaneous operation of the first electrical machine 20 and the second electrical machine 30, which jointly drive the first flywheel 50. This enables the rapid and energy-saving generation of the flywheel effect. And another advantage of the first embodiment 10 is that when the first flywheel 50 generates a flywheel effect, it has a dual benefit. On one hand, it allows the use of less electrical energy from the first electrical machine 20 to maintain the first flywheel 50 in the flywheel effect. On the other hand, the second motor device 30 can harness the flywheel effect of the first flywheel 50 to provide greater electrical power to the external environment. This allows for the energy-saving power generation effect in the first embodiment 10 to be realized.

According to an actual test of the first embodiment 10, when the first flywheel 50 remains in the flywheel effect state, the consumed electrical energy E1 provided jointly by the first electrical machine 20 and the second electrical machine 30 is about 5 HP=0.745 KW×5=3.73 KW, and the generated electrical energy E2 provided by the second electrical machine 30 is approximately 75% of its rated output power, E2=50 HP×75%=0.745 KW×50×75%=27.9 KW. In other words, the electrical energy generated by the first embodiment 10 is about 8 times the electrical energy consumed.

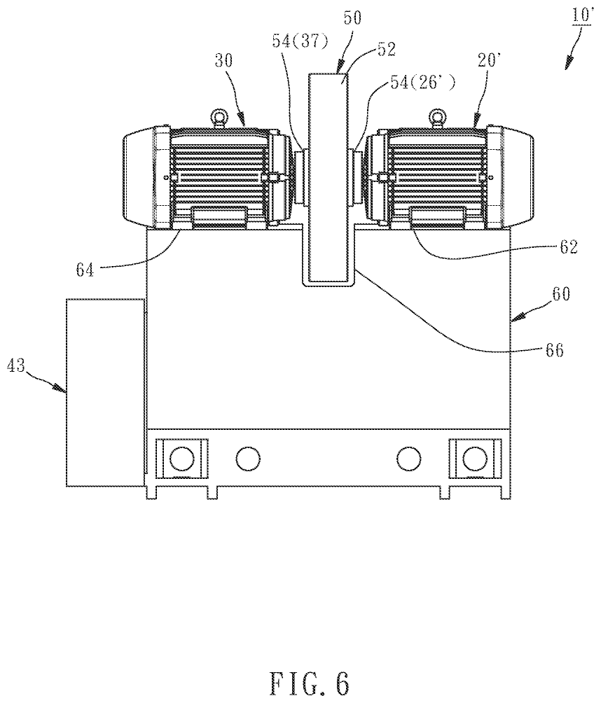

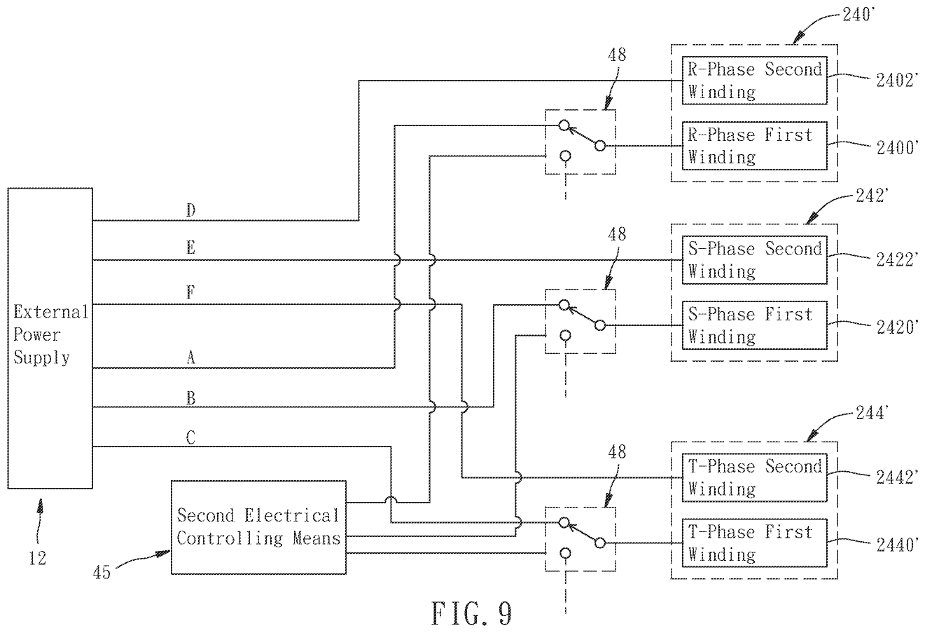

Referring next to FIG. 6 to FIG. 10, a second embodiment of the system for generating electricity in an energy-saving way according to the disclosure is shown at 10′. The difference between the second embodiment 10′ and the first embodiment 10 is that the second embodiment 10′ includes a first electrical machine 20′ with a second operating mode. The second operating mode is that the first electrical machine operates in a motor mode or in a motor mode and a generator mode simultaneously. In addition, for convenience of description, when the same components of the second embodiment 10′ and the first embodiment 10 are mentioned below, the reference numbers of the first embodiment 10 will be used. Moreover, for the convenience of description, the first electrical machine 20 and the electrical machine 20′ both use the same name “first electrical machine” but have different structures.

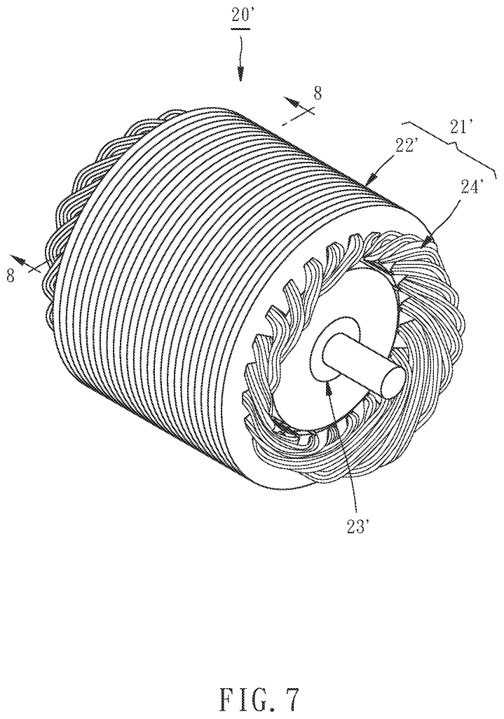

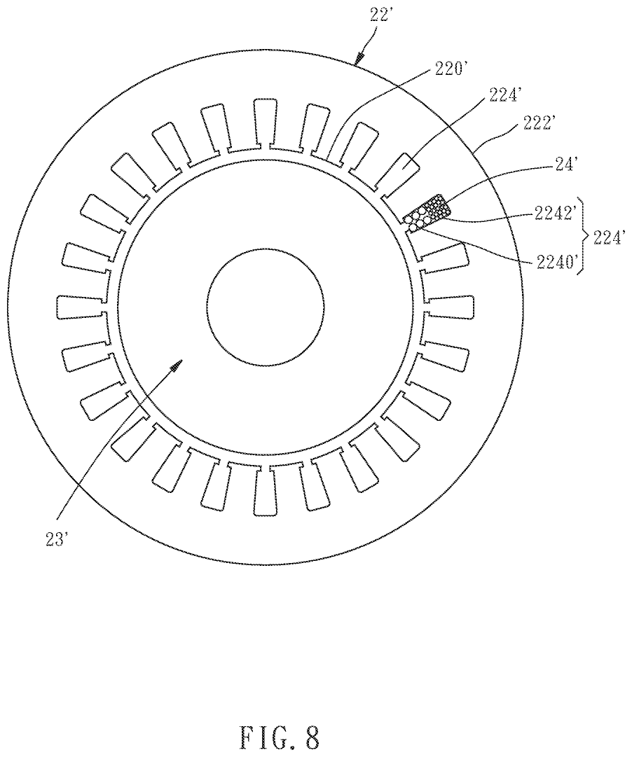

In this embodiment, the first electrical machine 20′ is a three-phase, four poles, three-phase electrical machine with a rated output power of 30 HP. As shown in FIG. 7 and FIG. 8,

The first electrical machine 20′ comprises a first stator 21′ and
a first rotor 23′ disposed in the first stator 21′. The first stator 21′ comprises a first stator body 22′ and a first stator winding 24′. The first stator body 22′, in this embodiment, is configured by stacking a plurality of annular silicon-steel sheets which includes an inner peripheral surface 220′, an outer peripheral surface 222′ and a plurality of slots 224′ spaced apart from each other and extends from the inner peripheral surface 220′ to the outer peripheral surface 222′. The first stator winding 24′ includes an R-phase winding set 240′, an S-phase winding set 242′ and a T-phase winding set 244′ which can be configured in a wye or delta connection. The R-phase winding set 240′ comprises an R-phase first winding 2400′ and an R-phase second winding 2402′. The S-phase winding set 242′ comprises an S-phase first winding 2420′ and an S-phase second winding 2422′. The T-phase winding set 244′ comprises a T-phase first winding 2440′ and a T-phase second winding 2442′.

In this embodiment, the rated output power of the R-phase, S-phase and T-phase first windings 2400′, 2420′ and 2440′ is 15 HP, and the rated output power of the R-phase. S-phase and T-phase second winds 2402′, 2422′ and 2442′ is also 15 HP. The R-phase, S-phase and T-phase first windings 2400′, 2420′ and 2440′ and the R-phase. S-phase and T-phase second winds 2402′, 2422′ and 2442′ have the same number of magnetic poles, for example four magnetic poles. The R-phase, S-phase and T-phase first windings 2400′, 2420′ and 2440′ are installed respectively in the first portion 2240′ of the slot 224′. The R-phase, S-phase and T-phase second winds 2402′, 2422′ and 2442′ are installed respectively in the second portion 2242′ of the slot 224′. The first rotor 23′ has a third number of magnetic poles and a first rotor shaft 26′. The third number of magnetic poles is the same as the first number of magnetic poles or the second number of magnetic poles.

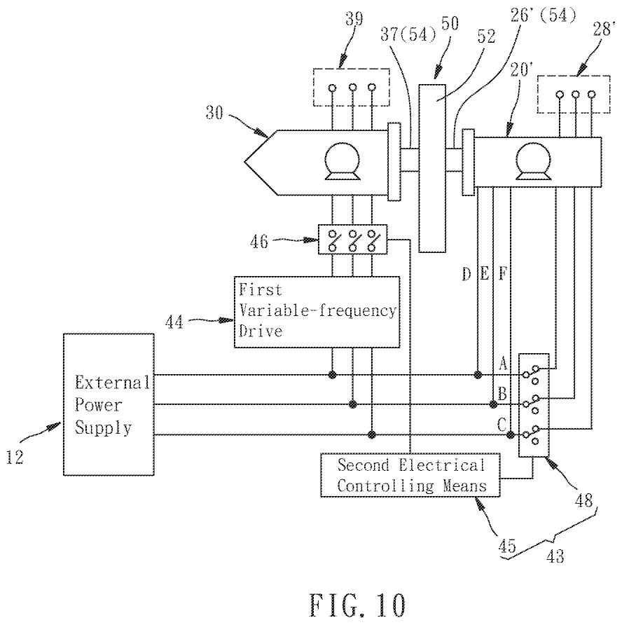

In addition, the second embodiment 10′ further includes a second controlling unit 43 having a third and fourth control mode. As shown in FIG. 10, the second controlling unit 43 includes a second electrical controlling means 45, a first variable-frequency drive 44, a three-phase first switch 46 and a three-phase second switch 48. The three-phase second switch 48 can also be a relay, an electromagnetic switch or other similar devices.

In this embodiment, the electrically connecting way of the second electrical controlling means 45, the first variable-frequency drive 44 and the three-phase first switch 46 is the same as that of the first electrical controlling means 41 and will not be described again here. Furthermore, the second electrical controlling means 45 is electrically connected to the three-phase second switch 48 to control the connection and disconnection thereof. Each phase output end of the three-phase second switch 48 is electrically connected to the R-phase. S-phase and T-phase first windings 2400′, 2420′ and 2440′ respectively. Each phase input end of the three-phase second switch 48 is electrically connected to the external power supply 12 through lines A. B, and C respectively.

The R-phase, S-phase and T-phase second winds 2402′, 2422′ and 2442′ are electrically connected to the external power supply 12 through lines D, E. and F. In this embodiment, one end of the drive shaft 54 of the first flywheel 50 is coupled to a first rotor shaft 26′ of the first electrical machine 20′.

Thereby, when the first flywheel 50 is to be started from a stationary state, the second controlling unit 43 is in the third control mode. Under the third control mode, as to drive the first electrical machine 20′, the three-phase second switch 48 is in the connection position by the control of the second electrical controlling means 45, thus, the R-phase, S-phase and T-phase first windings 2400′, 2420′ and 2440′ and the R-phase. S-phase and T-phase second winds 2402′, 2422′ and 2442′ are electrically connected to the external power supply 12 at the same time. Moreover, as the three-phase first switch 46 is in the connection position by the control of the second electrical controlling means 45, the second electrical machine 30 can be used as a motor through the first variable-frequency drive 44. In detail, under this circumstance, the first electrical machine 20′ is operated in the motor mode of the second operating mode, and the second electrical machine 30 is operated in the third operating mode so that the first flywheel 50 is driven jointly by the first electrical machine 20′ and the second electrical machine 30. In more detail, the total output power of the first electrical machine 20′ is 30 HP, that is, the rated output power 15 HP of the R-phase, S-phase and T-phase first windings adds the rated output power 15 HP of the R-phase, S-phase and T-phase second windings.

When the first flywheel 50 runs to a predetermined speed that generates the flywheel effect, the second controlling unit 43 will be operated in the fourth control mode. Under the fourth control mode, the three-phase second switch 48 is in disconnection position controlled by the second electrical controlling means 45, thus, only the R-phase, S-phase and T-phase second windings 2402′, 2422′ and 2442′ are electrically connected to the external power supply 12, that is, the first electrical machine 20′ is operated in the motor mode and the generator mode of the second operating mode at the same time. And the three-phase first switch 46 is in disconnection position controlled by the first electrical controlling means 41 so that the second electrical machine 30 is driven by the flywheel effect of the first flywheel 50 via the first electrical machine 20′ for operating as a generator, that is, in the fourth operating mode. In other words, when the second control unit 43 is in the second control mode, the first electrical machine 20′ will be operated in the generator mode through the flywheel effect of the first flywheel 50, and provide electrical power to the external environment through the first output end 28′ of the first motor 20′. And, at the same time, the second electrical machine 30 will also be operated in the generator mode through the flywheel effect of the first flywheel 50 and provide electrical energy to the external environment through the second output terminal 39 of the second electrical machine 30.

According to an actual test of the second embodiment 10′, when the first flywheel 50 remains in the flywheel effect state, the consumed electrical energy E1 provided jointly by the first electrical machine 20′ and the second electrical machine 30 is about 5 HP=0.745 KW×5=3.73 KW. The electrical efficiency of both the first and second electrical machine is 75% of their rated output power so that the generated electrical energy E2 of the first electrical machine 20′ plus the second electrical machine 30 is about (50 HP+15 HP)×75%=0.745 KW×65×75%=36.32 KW. In other words, the electrical energy generated by the second embodiment 10′ is about 10 times the electrical energy consumed.

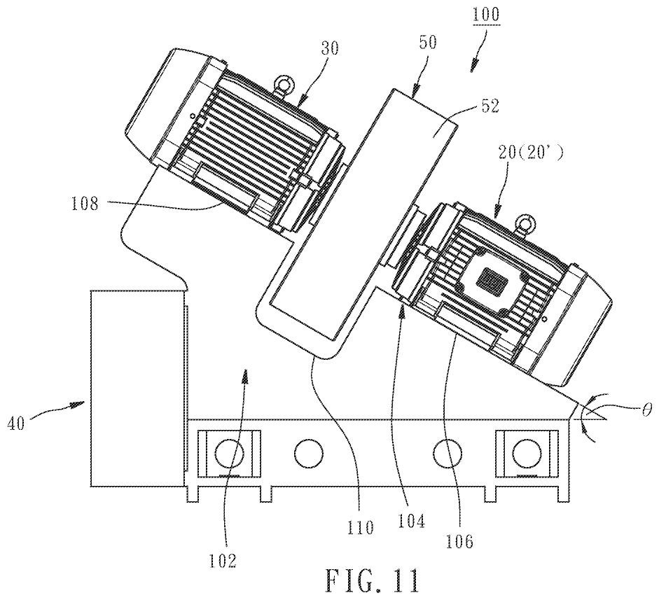

Next, referring to FIG. 11, a third embodiment of the system for generating electricity in an energy-saving way according to the disclosure is shown at 100. The difference between the third embodiment 100 and the first embodiment 10 is that the third embodiment 100 includes a second base 102 with an inclined surface 104. The included angle θ between the inclined surface 104 and a horizontal plane can be between 25° and 45°. In this embodiment, the included angle θ is 30°. The inclined surface 104 includes a first part 106, a second part 108 and a second recess 110 between the first and second part 106, 108. The first electrical machine 20 is mounted on the first part 106 and the second electrical machine 30 is mounted on the second part 108. A part of the first circular body 52 of the first flywheel 50 is suspended in the second recess 10. Thereby, the gravity of the first flywheel 50 can be reduced.

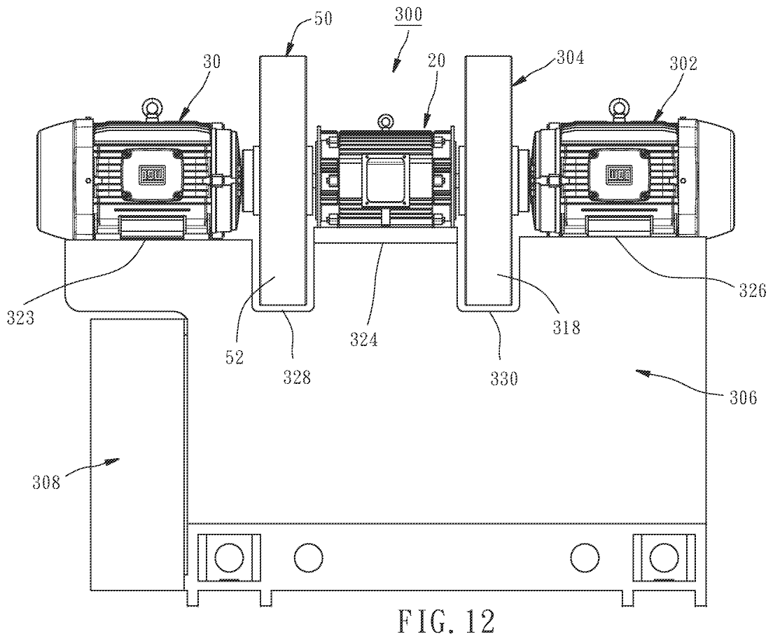

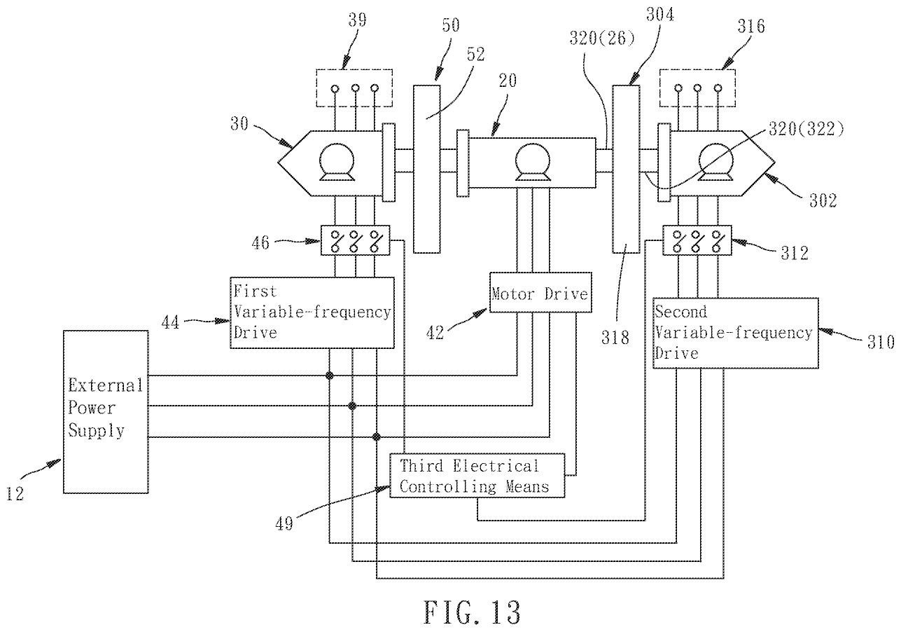

Referring then to FIG. 12 and FIG. 13, a fourth embodiment of the system for generating electricity in an energy-saving way according to the disclosure is shown at 300. The difference between the fourth embodiment 300 and the first embodiment 10 is that the former further includes a third electrical machine 302, a second flywheel 304, a third base 306 and a third controlling unit 308 with a fifth and sixth controlling modes.

The third electrical machine 302, in this embodiment, like the second electrical machine 30, is a conventional three-phase permanent magnet synchronous motor-generator with a rated output power of 50 HP. The third electrical machine 302 further has a fifth and sixth operating modes.

The third controlling unit 308 comprises a third electrical controlling means 49, a motor drive 42, a first variable-frequency drive 44 and a three-phase first switch 46. In addition, as shown in FIG. 13, the third controlling unit 308 further comprises a second variable-frequency drive 310 and a three-phase third switch 312. The second variable-frequency drive 310 has an input end electrically connected to the external power supply 12 and an output end electrically connected to an input end of the three-phase third switch 312. An output end of the three-phase third switch 312 is electrically connected to an input end of the third three-phase stator winding (not shown in FIG. 13) of the third electrical machine 302. When the three-phase third switch 312 is in the connection position by the control of the third electrical controlling means 49, the third electrical machine 302 can be operated as a motor through the second variable-frequency drive 310, that is, in a fifth operating mode. When the three-phase third first switch 312 is in the disconnection position by the control of the third electrical controlling means 49, the third electrical machine 302 is driven by the second flywheel 304 (the combination of the two will be described in detail below) via the first electrical machine 20 to be operated as a generator, that is, in a sixth operating mode.

The second flywheel 304 having the same structure as the first flywheel 50 includes a second circular body 318 with a predetermined weight and a second drive shaft 320. One end of the second drive shaft 320 is coupled to the first rotor shaft 26 of the first electrical machine 20 so that the second flywheel 304 can be driven by the first electrical machine 20. The other end of the second drive shaft 320 is coupled to a third rotor shaft 322 of the third electrical machine 302 so that when the third electrical machine 302 is operated in the motor mode, the second flywheel 304 is driven by the third electrical machine 302 and when the second flywheel 304 runs at a predetermined speed, the third electrical machine 30 is driven by the second flywheel 304 via the first electrical machine 20 to be operated in the generator mode.

The third base 306 includes a third seat 323, a fourth seat 324, a fifth seat 326, a third recess 328 between the third and fourth seats 323, 324 and a fourth recess 330 between the fourth and fifth seats 324, 326. The first electrical machine 20 is mounted on the fourth seat 324, the second electrical machine 30 is mounted on the third seat 323 and the third electrical machine 302 is mounted on the fifth seat 326. A part of the first circular body 52 of the first flywheel 50 is suspended in the third recess 328. A part of the second circular body 318 of the second flywheel 302 is suspended in the fourth recess 330.

Thereby, when the first flywheel 50 and the second flywheel 304 are to be started from a stationary state, the third controlling unit 308 is in the fifth control mode. Under the fifth control mode, the first electrical machine 20 is in the first operating mode via the motor drive 42 controlled by the third electrical controlling means 49, the second electrical machine 30 is in the third operating mode via the first frequency converter 44 and the three-phase first switch 46 which are controlled by the third electrical controlling means 49 and the third electrical machine 302 is in the fifth operating mode via the second variable-frequency drive 310 and the three-phase third switch 312 which are controlled by the third electrical controlling means 49. Thus, the first flywheel 50 will be driven by the combined force of the first electrical machine 20 and the second electrical machine 30 to start running, and the second flywheel 304 will be driven by the combined force of the first electrical machine 20 and the third electrical machine 302 to start running.

When the first flywheel 50 and the second flywheel 304 run to a predetermined speed that generates the flywheel effect, the third controlling unit 308 is in the sixth control mode. Under the sixth control mode, the first electrical machine 20 is still in the first operating mode controlled by the third electrical controlling means 49, the three-phase first switch 46 is in disconnection position controlled by the third electrical controlling means 49 so that the second electrical machine 30 is driven by the flywheel effect of the first flywheel 50 via the first electrical machine 20 to be operated as a generator, that is, in the fourth operating mode, and in the meantime, the three-phase third switch 312 is in disconnection position controlled by the third electrical controlling means 49 so that the third electrical machine 302 is driven by the flywheel effect of the second flywheel 304 via the first electrical machine 20 to be operated as a generator. In other words, when the third controlling unit 49 is in the sixth control mode, the second electrical machine 30 and the third electrical machine 302 will both be operated in the generator mode via the flywheel effects of the first flywheel 50 and the second flywheel 304 to provide electrical energy to the external environment through an output end 39 of the second electrical machine 30 and an output end 316 of the third electrical machine 302.

From the aforementioned description, it can be understood that the fourth embodiment 300 utilizes, at the same time, the first electrical machine 20 and the second electrical machine 30 to jointly drive the first flywheel 50, and the first electrical machine 20 and the third electrical machine 302 to jointly drive the second flywheel 304 so that it can quickly and energy-savingly produce the flywheel effects. And when the first flywheel 50 and the second flywheel 304 generate the flywheel effect, on the one hand, the first electrical machine 20 can be used as a driver to maintain the first flywheel 50 and the second flywheel 304 in the flywheel effect, on the other hand, the second electrical machine 30 and the third electrical machine 302 can both supply a predetermined electrical energy to the external environment through the flywheel effect of the first flywheel 50 and the second flywheel 304. Therefore, the energy-saving power generation effect of the third embodiment 300 is thus produced.

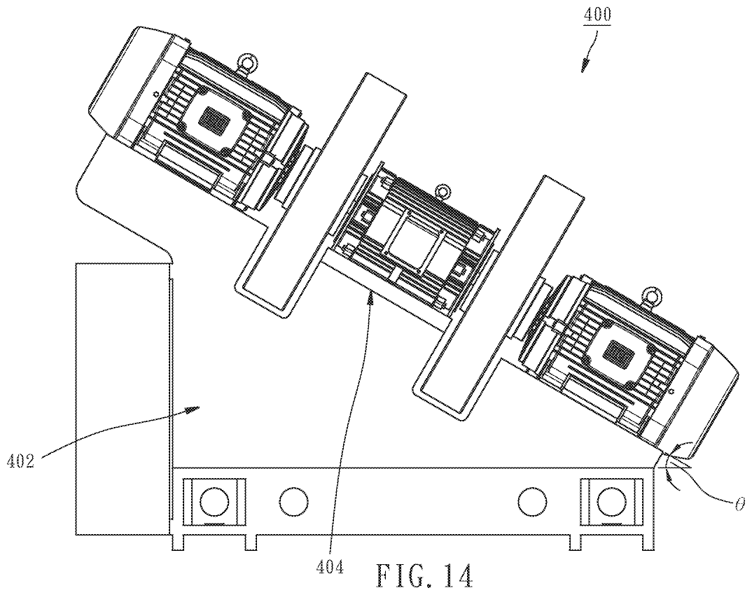

Referring lastly to FIG. 14, a fifth embodiment of the system for generating electricity in an energy-saving way according to the disclosure is shown at 400. The difference between the fifth embodiment 400 and the fourth embodiment 300 is that the former includes a fourth base 402 with an inclined seat surface 404. The included angle θ between the inclined seat surface 404 and a horizontal plane is generally 25° to 45°, preferably is 30°.

What is claimed is:

1. A method for generating electricity in an energy-saving way, the method including the steps of:
preparing a first electrical machine, the first electrical machine having a first or second operating mode wherein the first operating mode is that the first electrical machine operates in a motor mode, and the second operating mode is that the first electrical machine operates in a motor mode or in a motor mode and a generator mode at the same time;
preparing a second electrical machine, the second electrical machine having a third and fourth operating modes, wherein the third operating mode is that the second electrical machine operates in a motor mode, and the fourth operating mode is that the second electrical machine Operate in generator mode;
coupling a first flywheel to the first electrical machine and the second electrical machine respectively;
driving the first flywheel in a first control mode when it is in a stationary state wherein the first control mode is that the first electrical machine is operated in the first operating mode or the second operating mode that operates in a motor mode and the second electrical machine is operated in the third operating mode; and
driving the first flywheel in a second control mode when it runs at a predetermined speed wherein the second control mode is that the first electrical machine is operated in the first operating mode or in the second operating mode that operates in a motor mode and a generator mode at the same time, and the second electrical machine is operated in the fourth operating mode.

2. The method of generating electricity in an energy-saving way, further comprising the following steps:
preparing a third electrical machine, the third electrical machine having a fifth and sixth operating mode wherein the fifth operating mode is that the third electrical machine operates in a motor mode, and the sixth operating mode is that the third electrical machine operates in a generator mode;
coupling a second flywheel to the first electrical machine and the third electrical machine respectively;
driving the second flywheel in a third control mode when it is in a stationary state wherein the third control mode is that the first electrical machine is operated in the first operating mode or the second operating mode the operates in a motor mode and the third electrical machine is operated in the fifth operating mode; and
driving the second flywheel in a fourth control mode when it runs at a predetermined speed wherein the fourth control mode is that the first electrical machine is operated in the first operating mode or the second operating mode that operates in a motor mode and a generator mode at the same time and the third electrical machine is operated in the sixth operating mode.

3. A system for generating electricity in an energy-saving way, the system comprising:
a first electrical machine having a first or second operating mode wherein the first operating mode is that the first electrical machine operates in a motor mode, and the second operating mode is that the first electrical machine operates in a motor mode or in a motor mode and a generator mode at the same time;
a second electrical machine having a third and fourth operating modes wherein the third operating mode is that the second electrical machine operates in a motor mode, and the fourth operating mode is that the second electrical machine operates in a generator mode;
a first flywheel coupled to the first electrical machine and the second electrical machine respectively; and
a first controlling unit having a first and second control mode wherein the first control mode is to operate the first electrical machine in the first operating mode or the second operating mode that operates in a motor mode and the second electrical machine in the third operating mode for driving the first flywheel from a stationary state, and the second control mode is to operate the first electrical machine in the first operating mode or the second operating mode that operates in a motor mode and a generator mode at the same time and the second electrical machine in the fourth operating mode when the first flywheel runs at a predetermined speed.

4. The system of claim 3, wherein the first electrical machine comprises a motor.

5. The system of claim 4, wherein the second electrical machine comprises a motor-generator.

6. The system of claim 5, wherein the second electrical machine comprises a second stator and a second rotor, the second stator comprises a second stator body and a second three-phase stator winding disposed in the stator body, the second rotor comprises a second rotor body and a plurality of permanent magnets are respectively disposed on the second rotor body, whereby, when the first flywheel is to run from a stationary state, the second electrical machine is controlled by the first control mode in a way that the second electrical machine can be operated in a motor mode and when the first flywheel runs at a predetermined speed, the second electrical machine is controlled by the second control mode in a way that the second electrical machine operate in a generator mode.

7. The system of claim 6, wherein the first controlling unit comprises a first electrical controlling means, a first variable-frequency drive and a three-phase first switch; the first electrical machine is electrically connected to an external power supply via the first electrical controlling means for being controlled thereby, the first electrical controlling means is electrically connected to the three-phase first switch to control the connection and disconnection of the three-phase first switch; the first variable-frequency drive is electrically connected to an external power supply and to the second electrical machine via the three-phase first switch; whereby, when the three-phase first switch is in the connection state by the control of the first electrical controlling means, the second electrical machine can be operated in a motor mode via the first variable-frequency drive, that is, in the third operating mode and when the three-phase first switch is in the disconnection state by the control of the first electrical controlling means, the second electrical machine can be operated in a generator mode, that is, in the fourth operating mode.

8. The system of claim 3, wherein the first electrical machine comprises a first stator and a first rotor; the first stator comprises a first stator body and a three-phase first stator winding disposed in the stator body, each phase first stator winding of the three-phase first stator winding comprises a first winding having a first number of magnetic poles and a first rated output power, and a second winding having a second number of magnetic poles and a second rated output power, the first number of magnetic poles is equal to the second number of magnetic poles, the first rated output power is greater than or equal to the second rated output power; and the first rotor comprises a third number of magnetic poles and a shaft, the third number of magnetic poles is the same as the first number of magnetic poles or the second number of magnetic poles; whereby, when the first winding and the second winding are simultaneously electrically connected to an external power supply by the control of the first controlling unit, the first electrical machine is operated in the second operating mode that operates in a motor mode; and when only the second winding is electrically connected to the external power supply by the control of the first controlling unit, the first electrical machine is operated in the second operating mode that operates in a motor mode and a generator mode at the same time.

9. The system of claim 8, wherein the second electrical machine comprises a second stator and a second rotor, the second stator comprises a second stator body and a second three-phase stator winding disposed in the stator body, the second rotor comprises a second rotor body and a plurality of permanent magnets are respectively disposed on the second rotor body, whereby, when the first flywheel is to run from a stationary state, the second electrical machine is controlled by the first control mode in a way that the second electrical machine can be operated in a motor mode and when the first flywheel runs at a predetermined speed, the second electrical machine is controlled by the second control mode in a way that the second electrical machine operate in a generator mode.

10. The system of claim 9, wherein the first controlling unit comprises a second electrical controlling means, a first variable-frequency drive, a three-phase first switch and a three-phase second switch; the second electrical controlling means is electrically connected to the three-phase first switch to control the connection and disconnection thereof, the first variable-frequency drive is electrically connected to an external power supply and to the second three-phase stator winding of the second electrical machine via the three-phase first switch; the second electrical controlling means is electrically connected to the three-phase second switch to control the connection and disconnection thereof, an input end of the three-phase second switch is electrically connected to the external power supply, the first winding of the first electrical machine is electrically connected to an output end of the three-phase second switch, the second winding of the first electrical machine is electrically connected to the external power supply, whereby, when the three-phase first switch is in the connection state by the control of the second electrical controlling means, the second electrical machine can be operated in a motor mode via the first variable-frequency drive, that is, in the third operating mode and when the three-phase first switch is in the disconnection state by the control of the first electrical controlling means, the second electrical machine can be operated in a generator mode, that id, in the fourth operating mode, when the three-phase second switch is in the connection state by the control of the second electrical controlling means, the first winding and the second winding of the first electrical machine are electrically connected to an external power supply via the three-phase second switch so that the first electrical machine can be operated in the second operating mode that operates in a motor mode, when the three-phase second switch is in the disconnection state by the control of the second electrical controlling means, only the second winding is electrically connected to the external power supply, that is, the first electrical machine is operated in the second operating mode that operates in a motor mode and a generator mode at the same time.

11. The system of claim 3, further comprising a first base including a first seat, a second seat and a first recess between the first and second seat, wherein the first electrical machine is mounted on the first seat, the second electrical machine is mounted on the second seat and a part of the first flywheel is suspended in the first recess.

12. The system of claim 11, wherein the first seat and the second seat are arranged on an inclined surface and the included angle θ between the inclined surface and a horizontal plane is 25° to 45°.

13. The system of claim 3, further comprising a third electrical machine having a fifth and sixth operating modes wherein the fifth operating mode is that the third electrical machine operates in a motor mode, and the sixth operating mode is that the third electrical machine operate in a generator mode; a second flywheel coupled to the first electrical machine and the third electrical machine respectively; and
the fist controlling unit further having a third control mode wherein the third control mode is to operate the first electrical machine in the first operating mode or the second operating mode that operates in a motor mode and the third electrical machine in the fifth operating mode for driving jointly the second flywheel from a stationary state, and to operate the first electrical machine in the first operating mode or the second operating mode that operates in a motor mode and a generator mode at the same time and the third electrical machine in the sixth operating mode when the first flywheel runs at a predetermined speed.

14. The system of claim 13, wherein the first electrical machine comprises a motor, the second electrical machine comprises a first three-phase permanent magnet synchronous motor-generator, and the third electrical machine comprises a second three-phase permanent magnet synchronous motor-generator.

15. The system of claim 13, wherein the second electrical machine comprises a first three-phase permanent magnet synchronous motor-generator, the third electrical machine comprises a second three-phase permanent magnet synchronous motor-generator, the first electrical machine comprises a first stator and a first rotor; the first stator comprises a first stator body and a three-phase first stator winding disposed in the stator body, each phase first stator winding of the three-phase first stator winding comprises a first winding having a first number of magnetic poles and a first rated output power, and a second winding having a second number of magnetic poles and a second rated output power, the first number of magnetic poles is equal to the second number of magnetic poles, the first rated output power is greater than or equal to the second rated output power; and the first rotor comprises a third number of magnetic poles and a shaft, the third number of magnetic poles is the same as the first number of magnetic poles or the second number of magnetic poles; whereby, when the first winding and the second winding are simultaneously electrically connected to an external power supply by the control of the first controlling unit, the first electrical machine is operated in the second operating mode that operates in a motor mode of; and when only the second winding is electrically connected to the external power supply by the control of the first controlling unit, the first electrical machine is operated in the second operating mode that operates in a motor mode and a generator mode at the same time.

16. The system of claim 14, wherein the first controlling unit comprises a third electrical controlling means, a motor drive, a first variable-frequency drive, a second variable-frequency drive, a three-phase first switch and a three-phase second switch; the third electrical controlling means is electrically connected to the motor drive to control the operation thereof, the first electrical machine is electrically connected to an external power supply via the motor drive so that the first electrical machine can be in the first operating mode via the motor drive controlled by the third electrical controlling means, the third electrical controlling means is electrically connected to the three-phase first switch to control the connection and disconnection thereof, the first variable-frequency drive is electrically connected to the external power supply and to the second electrical machine via the three-phase first switch, the third electrical controlling means is electrically connected to the three-phase second switch to control the connection and disconnection thereof, the second variable-frequency drive is electrically connected to the external power supply and to the third electrical machine via the three-phase second switch; whereby, when the three-phase first switch is in the connection state by the control of the third electrical controlling means, the second electrical machine can be operated in a motor mode via the first variable-frequency drive, that is, in the third operating mode and when the three-phase first switch is in the disconnection state by the control of the third electrical controlling means, the second electrical machine can be operated in a generator mode, that is, in the fourth operating mode, when the three-phase second switch is in the connection state by the control of the third electrical controlling means, the third electrical machine can be operated in a motor mode via the second variable-frequency drive, that is, in the fifth operating mode and when the three-phase second switch is in the disconnection state by the control of the third electrical controlling means, the third electrical machine can be operated in a generator mode, that is, in the sixth operating mode.
